(19) United States
(12) Patent Application Publication
(10) Pub. No.: US 2019/0180594 A1
(43) Pub. Date: Jun. 13, 2019

(54) INTEGRATED THERMOPHYSIOLOGICAL STRESS WARNING DEVICE

(71) Applicant: Scott Technologies, Inc., Monroe, NC (US)

(72) Inventor: Cedric Williams, Harrisburg, NC (US)

(21) Appl. No.: 16/093,279

(22) PCT Filed: Apr. 14, 2017
(86) PCT No.: PCT/US2017/027666

§ 371 Date: Oct. 12, 2018

Related U.S. Application Data
(60) Provisional application No. 62/323,137, filed on Apr. 15, 2016.

(51) Int. Cl. G08B 21/12; A62B 9/00

(52) U.S. Cl. CPC G08B 21/12; A62B 18/08; A62B 9/006

(57) ABSTRACT

According to one embodiment, an integrated protective equipment is provided. The integrated protective equipment includes a protective gear and at least one sensor affixed to the protective gear. The at least one sensor is configured to generate sensor data. The integrated protective gear includes processing circuitry affixed to the protective gear and in communication with the at least one sensor. The processing circuitry includes a processor and a memory. The memory contains instructions that, when executed by the processor, configure the processor to receive generated sensor data, and trigger an alert if the sensor data meet a predefined criteria, the predefined criteria include at least one threshold condition.

### FIELD

The present invention relates to integrated protective equipment, and in particular to a method and system for monitoring at least one harmful condition and alerting a person about the harmful condition using the integrated protective equipment.

### BACKGROUND

There are significant dangers posed by work in hot environments. Even more so, by high intensity work in environments of extreme heat stress, where the body is not able to maintain steady state due to clothing or required protective equipment. For example, firefighters are often exposed to such environments when responding to emergency situations in which the temperature of the environment could reach over five hundred degrees Celsius. Further, there is a buildup of heat, i.e., increase in body temperature, from various factors. For example, there is buildup of heat from physical activity and heat flux from the environment such as high ambient air temperature and radiant heat. Also, there is a buildup of heat from factors that restrict the body's natural cooling mechanisms such as impermeable clothing and humidity.

One problem associated with the build of heat is that it can result in thermal injury to the person. For example, it is well known that body core temperature above 40 degrees Celsius can result in thermal injury. The U.S. Occupational Health and Safety Administration (OHSA) recommends that the body core temperature not exceed 38 degrees Celsius for an extended period of time in order to avoid thermal injury.

A firefighter can wear a separate temperature reading device, but such a device requires the firefighter to periodically check the device reading. In some cases, this may require the firefighter to check his/her wrist where the device is located, thereby disadvantageously causing the firefighter to avert his/her attention from the dangerous environment to check the temperature readings.

### SUMMARY

The present invention advantageously provides a method and system for monitoring at least one harmful condition and alerting a person about the harmful condition using integrated protective equipment.

According to one embodiment of the disclosure, an integrated protective equipment is provided. The integrated protective equipment includes a protective gear and at least one sensor affixed to the protective gear. The at least one sensor is configured to generate sensor data. The integrated protective equipment includes processing circuitry affixed to the protective gear and in communication with the at least one sensor. The processing circuitry includes a processor and a memory. The memory contains instructions that, when executed by the processor, configure the processor to receive generated sensor data, and trigger an alert if the sensor data meet a predefined criteria, the predefined criteria include at least one threshold condition.

According to one embodiment of this aspect, the memory includes further instructions that, when executed by the processor, cause the processor to determine analysis data based on the received sensor data, and trigger an alert if the analysis data meet a predefined criteria, the predefined criteria include at least one threshold condition. According to another embodiment of this aspect, the sensor data includes a plurality of measurement values, and the analysis data indicates an average value of the plurality of measurement values over a predefined period of time. According to another embodiment of this aspect, wherein the sensor is a temperature sensor. The predefined criteria includes at least one temperature threshold condition.

According to another embodiment of this aspect, the at least one sensor is a plurality of sensors. The plurality of sensors include at least two different types of sensors. According to another embodiment of this aspect, at least one of the plurality of sensors is configured to measure a temperature of a user of the integrated protective equipment. At least one other of the plurality of sensors is configured to measure a characteristic of an environment where integrated protective equipment is located. According to another embodiment of this aspect, the protective gear is a face mask.

According to another embodiment of the disclosure, a method for integrated protective equipment including a protective gear and at least one sensor affixed to the protective gear is provided. The at least one sensor is configured to generate sensor data. The generated sensor data is received. An alert is triggered if the sensor data meets a predefined criteria. The predefined criteria includes at least one threshold condition.

According to one embodiment of this aspect, analysis data is determined based on the received sensor data. An alert is triggered if the analysis data meets a predefined criteria. The predefined criteria includes at least one threshold condition. According to another embodiment of this aspect, the sensor data includes a plurality of measurement values. The analysis data indicates an average value of the plurality of measurement values over a predefined period of time. According to another embodiment of this aspect, the sensor data is temperature data. The predefined criteria includes at least one temperature threshold condition.

According to another embodiment of this aspect, the at least one sensor is a plurality of sensors, the plurality of sensors including at least two different types of sensors. According to another embodiment of this aspect, at least one of the plurality of sensors is configured to measure a temperature of a user of the integrated protective equipment. At least one other of the plurality of sensors is configured to measure a characteristic of an environment where integrated protective equipment is located. According to another embodiment of this aspect, the protective gear is a protective mask.

According to another embodiment of the disclosure, an integrated protective equipment is provided. The integrated protective equipment includes a sensor module configured to generate sensor data. The face mask includes a condition module in communication with the sensor module. The condition module is configured to receive generated sensor data, and trigger an alert if the sensor data meet a predefined criteria. The predefined criteria includes at least one threshold condition.

According to another embodiment of the disclosure, an integrated protective equipment is provided. The integrated protective equipment includes a protective gear. The protective gear is a face mask. The integrated protective equipment includes a plurality of sensors configured to generate sensor data, the plurality of sensors including at least two different types of sensors of which at least one type is a human temperature sensor. The integrated protective equipment includes processing circuitry in communication with the at least one sensor. The processing circuitry includes a processor and a memory. The memory contains instructions that, when executed by the processor, configure the processor to: receive the generated sensor data, determine analysis data by performing an analysis of the generated sensor data, and trigger an alert if the analysis data meets a predefined criteria, the predefined criteria include at least one human temperature threshold condition. The analysis data includes an average measurement value over a period of time.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary system for monitoring at least one harmful condition using integrated protective equipment in accordance with the principles of the disclosure;

FIG. 2 is a flow diagram of an exemplary harmful condition process in accordance with the principles of the disclosure;

FIG. 3 is flow diagram of another exemplary harmful condition process in accordance with the principles of the disclosure;

FIG. 4 is a front view of one embodiment of the integrated protective equipment in accordance with the principles of the disclosure;

FIG. 5 is a side view of one embodiment of the integrated protective equipment in accordance with the principles of the disclosure; and

FIG. 6 is another embodiment of integrated protective equipment in accordance with the principles of the disclosure.

### DETAILED DESCRIPTION

In one or more embodiments, integrated protective equipment is configured to perform a harmful condition process for alerting a user of the integrated protective equipment when a potential harmful condition is detected.

Before describing in detail exemplary embodiments that are in accordance with the disclosure, it is noted that the embodiments reside primarily in combinations of equipment/device components and processing steps related to monitoring at least thermal condition. Accordingly, components have been represented where appropriate by conventional symbols in drawings, showing only those specific details that are pertinent to understanding the embodiments of the disclosure so as not to obscure the disclosure with details that will be readily apparent to those of ordinary skill in the art having the benefit of the description herein.

As used herein, relational terms, such as “first,” “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

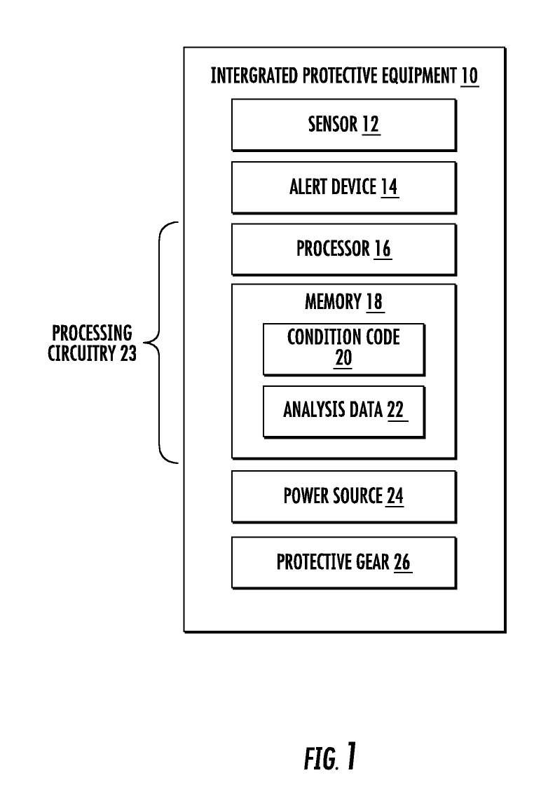

Referring now to drawing figures in which like reference designators refer to like elements there is shown in FIG. 1 an exemplary integrated protective equipment system for performing the harmful condition process in accordance with the principles of the disclosure and designated generally as “10.” In one or more embodiments, integrated protective equipment 10 includes various components and a face mask, as discussed herein. In one or more other embodiments, integrated protective equipment 10 can be another type of protective equipment with integrated sensor(s).

Integrated protective equipment 10 includes one or more sensors 12 integrated into the protective equipment. In one or more embodiments, one or more sensors 12 includes at least one of a thermistor, solid state temperature sensor, blood-oxygen sensor, motion sensor, humidity sensor, acceleration sensor, force measurement sensor, pressure sensor, chemical sensor, thermal sensor, heat sensor, biosensor, optical sensor, carbon monoxide sensor, oxygen sensor, and other sensors known in the art. However, the variety of sensors 12 may be specifically integrated in equipment 10 such as to provide measurements of the user and/or of the environment such as to allow more accurate detection of harmful conditions. In one example, several sensors 12 may be configured to make physical contact with the user of integrated protective equipment 10 in order to a user's physical or physiological characteristics, such as body temperature and/or blood oxygen, while other sensors 12 may be configured to measure the temperature of the integrated protective equipment 10, itself, and/or of the environment that integrated protective equipment 10 is located within.

Integrated protective equipment 10 includes alert device 14 for providing an alert to the user of integrated protective equipment 10. In one or more embodiments, alert device 14 provides at least one of visual feedback, audio feedback and haptic feedback regarding at least one harmful condition, such as temperature exceeding a predetermined threshold. For example, in one or more embodiments, alert device 14 is an LCD and/or LED based display for providing visual feedback to the user of integrated protective equipment 10. In another example, in one or more embodiments, alert device 14 is one or more audio speakers that provide audio feedback to the user of integrated protective equipment 10. In another example, in one or more embodiments, alert device 14 is a haptic device that provides haptic feedback to the user of integrated protective equipment 10. Alert device 14 may also include a transmitter or transceiver to wirelessly alert another person or monitoring center that a harmful condition has occurred and optionally, what that harmful condition is, e.g., excess temperature. For example, alert device 14 may signal to other integrated protective equipment 10 in the incident area regarding the alert, thereby alerting other personnel using the other integrated protective equipment 10 about the alert. In one or more embodiments, integrated protective equipment 10 receives an alert generated by another integrated protective equipment 10 and displays this alert via the alert device 14. This wireless alert may serve as a warning to other personnel using other integrated protective equipment 10 to stay away from a particular area or that a particular person wearing integrated protective equipment 10 may need help. Such a wireless alert can be made, for example via the transmitter/transceiver using a wide area communication technology, such as cellular communications, or via a short range communication technology such as Wi-Fi, Bluetooth, etc. In the case of a short range communication technology, the transmitter/transceiver may be configured to communicate with a smart phone or other device carried by the user.

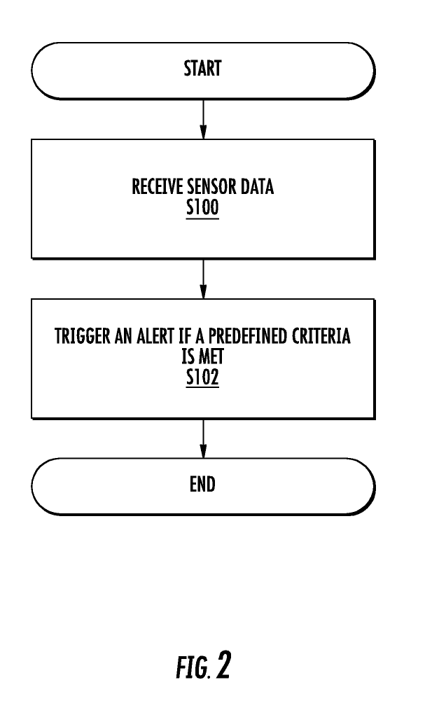

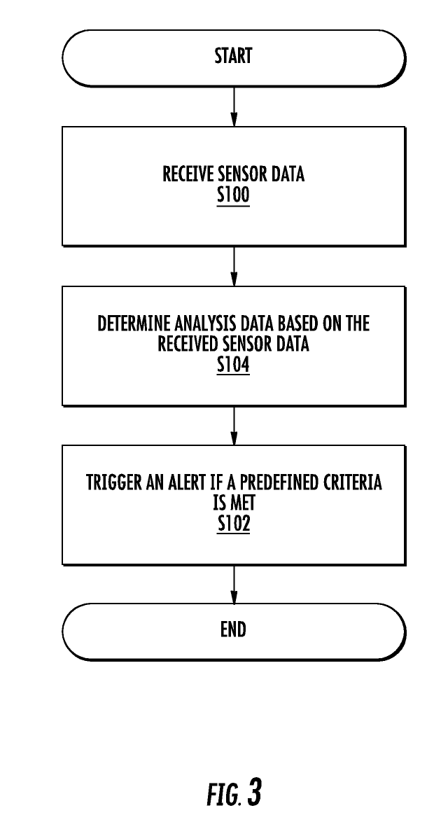

Integrated protective equipment 10 includes one or more processors 16 for integrated protective equipment 10 functions described herein. Processor 16 is in communication with sensor 12. Integrated protective equipment 10 includes memory 18 in communication with processor 16 that is configured to store data such as temperature data, and programmatic software code and/or other information described herein. Memory 18 is configured to store condition code 20. For example, condition code 20 includes instructions that, when executed by processor 16, causes processor 16 to perform the harmful condition process discussed in detail with respect to FIGS. 2-3. In one or more embodiments, memory 18 is further configured to store sensor data and/or analysis data 22 generated from the analysis of sensor data, as discussed herein.

In one or more embodiments, processor 16 and memory 18 form processing circuitry 23. In addition to a traditional processor and memory, processing circuitry 23 may comprise integrated circuitry for processing and/or control, e.g., one or more processors and/or processor cores and/or FPGAs (Field Programmable Gate Array) and/or ASICs (Application Specific Integrated Circuitry). Processor 16 may be configured to access (e.g., write to and/or reading from) memory 18, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Such memory 18 may be configured to store code executable by processor 16 and/or other data, e.g., data pertaining to communication, e.g., configuration of sensors, etc. Processing circuitry 23 may be configured to control any of the methods and/or processes described herein and/or to cause such methods and/or processes to be performed, e.g., by integrated protective equipment 10. Corresponding instructions may be stored in the memory 18, which may be readable and/or readably connected to processor 16.

Integrated protective equipment 10 includes one or more power sources 24. In one or more embodiment, power source 24 is a battery such as a disposable battery and/or rechargeable battery. Power source 24 powers the elements of integrated protective equipment 10, i.e., powers active/semi-active sensors 12, alert device 14, processor 16 and memory 18, among other elements/components that may be included in integrated protective equipment 10. Integrated protective equipment 10 includes protective gear 26. In one or more embodiments, protective gear 26 is face mask or other wearable gear.

FIG. 2 is a flow diagram of an exemplary harmful condition process of condition code 20. Processing circuitry 23 receives sensor data (Block S100). In one or more embodiments, processing circuitry 23 receives sensor data from one or more sensors 12. For example, the received sensor data may indicate one or more measurements performed by sensor 12 such as a temperature measurement. In one or more embodiments, sensor data includes various measurements from at least two different types of sensor such as a temperature sensor and oxygen sensor, blood oxygen sensor, among other different types of sensors.

Processing circuitry 23 triggers an alert if a predefined criteria is met (Block S102). In one or more embodiments, the predefined criteria includes one or more threshold conditions set by one or more users such that an alert is triggered if the one or more threshold conditions are met. The thresholds conditions are associated with one or more sensors 12. For example, in one or more embodiments, the predefined criteria may include a temperature threshold condition where an alert is triggered if the sensor data meets the temperature threshold condition, e.g., a temperature threshold condition (x>120 degrees Fahrenheit) where a measured temperature is greater than 120 degrees Fahrenheit or other preconfigured temperature. In another example, in one or more embodiments, the predefined criteria may include an oxygen level threshold condition (x<17% or x<14%) such as a minimum oxygen level of seventeen percent, fourteen percent or other predefined minimum oxygen level where the predefined criteria is met if the oxygen level falls below the minimum oxygen level. In another example, in one or more other embodiments, the predefined criteria includes at least a maximum temperature threshold condition, e.g., temperature >120 degrees Fahrenheit, and a minimum oxygen level threshold, e.g., oxygen level <seventeen percent oxygen, such that the predefined criteria is met if the temperature exceeds 120 degrees Fahrenheit and fall below seventeen percent oxygen. The ranges and threshold values here are merely examples, it being understood that the ranges and values may be different depending on factors such as environmental conditions, age/heath of the user, designed safety factors, etc.

The predefined criteria may include other threshold conditions that indicate thermos-physiological stress of a person/user. In one or more embodiments where multiple sensors 12 are used, the predefined criteria includes a threshold condition for each sensor 12 such that the predefined criteria is met if the sensor data meets each threshold condition or meets one or more thresholds conditions. As used herein, meeting a threshold condition includes sensor data and/or temperature data being “less than,” “equal to,” “greater than,” “less than or equal to,” or “greater than or equal to” to the threshold. A threshold condition is not limited to the use of inequalities and may include Boolean operators or other logic based functions/equations.

The specific configuration for how many threshold conditions must be met by the sensor data may be set by one or more users or by an operator at a monitoring center via the above-described transceiver. Further, an alert may be triggered if sensor data from at least one sensor meets an error threshold condition such as to indicate that at least one sensor is not working properly. The error threshold condition may be a predefined difference between two measurements.

In one or more embodiments, the alert includes triggering at least one of a visual, audio and haptic based alert such as to provide feedback to the user about the potentially harmful condition. For example, the alert may include triggering alert device 16, i.e., a display in this embodiment, to display a visual warning to the user. In one or more embodiment, the visual warning includes the display of at least some sensor data. In another example, the alert may include triggering alert device 16, i.e., a speaker or other device capable of providing audio in this embodiment, to produce an audio warning. In yet another example, the alert may trigger alert device 16, i.e., a haptic feedback device in this embodiment such as a vibration element/device/mechanism, to alert the user of personal protective equipment 12 of the potentially harm condition via vibration, movement or motion.

In one or more embodiments, integrated protective equipment 10 includes a cooling device (not shown) that is integrated into protective gear 26. The cooling device may be triggered to operate, i.e., start cooling or get cold, when one or more alerts are triggered such as an alert based on human temperature of the personnel wearing the integrated protective equipment 10. Further, in one or more embodiments, the cooling device is configured to be proximate the user's “cooling spots” such as the neck when protective gear 26 is worn by the user. In one embodiment, the cooling device is powered by power source 24.

FIG. 3 is a flow diagram is another exemplary harmful condition process of condition code 20. Blocks S100 and Block S102 as described above with respect to FIG. 2, except Block S102 may be trigger based on sensor data and/or temperature data (described below). Processing circuitry 23 determines analysis data by analyzing the received sensor data, i.e., determines analysis data based on sensor data (Block S104). In one or more embodiments, processing circuitry 23 determines analysis data to be an average value of a measurement value indicated in sensor data over a predefined period of time. For example, processing circuitry 23 determines the average temperature over a period of thirty seconds is thirty-five degrees Celsius. In one or more embodiments, one or more other analysis of the sensor data are performed to generate different analysis data.

Processing circuitry 23 triggers an alert if the predefined criteria is met by the sensor data (discussed above) and/or temperature data (Block S102). Continuing the example above with respect to temperature data, the predefined criteria includes a threshold condition where an alert will be triggered if the average temperature over a predefined period of time, e.g., thirty seconds, is equal to thirty-eight degrees Celsius. Therefore, an alert will not be triggered since the average temperature determined by processing circuitry 23, i.e., thirty-five degrees Celsius, does not meet the predefined criteria including a threshold condition of thirty-eight degrees Celsius. In another example, sensor data indicates the oxygen level is at fifteen percent while the temperature data indicates the temperature or average temperature is 110 degrees Fahrenheit, and the minimum oxygen threshold is set to seventeen percent and the maximum temperature threshold is set to 110 degrees Fahrenheit.

It is also contemplated that multiple sensors 12 can be used and read, and averages among the sensors or differences in temperature used to trigger an alert. These sensors 12 can be positioned adjacent one another or separated and places in different unobtrusive locations within the integrated protective equipment 10.

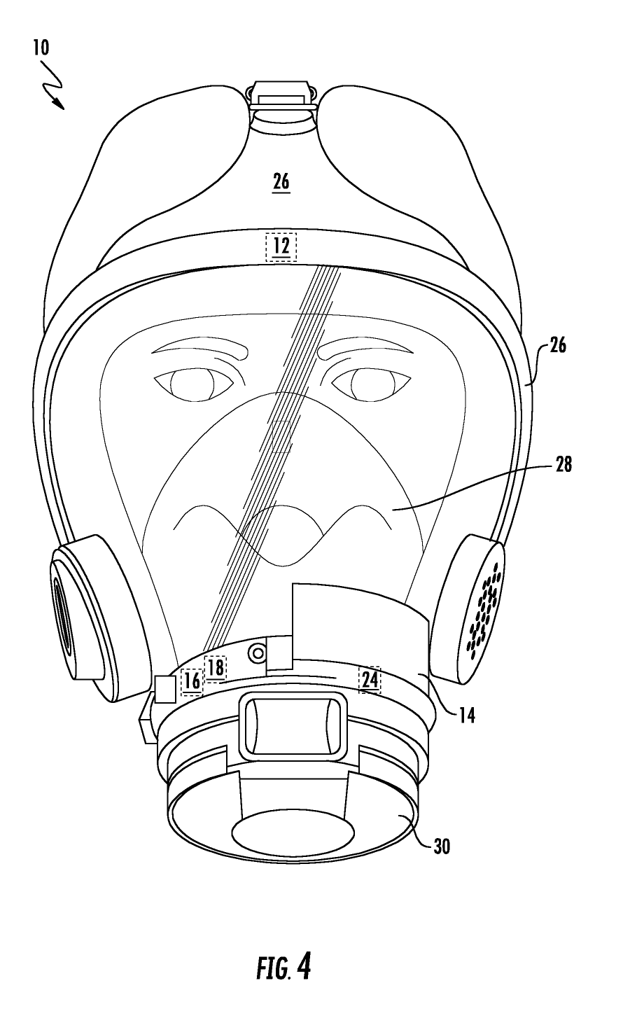

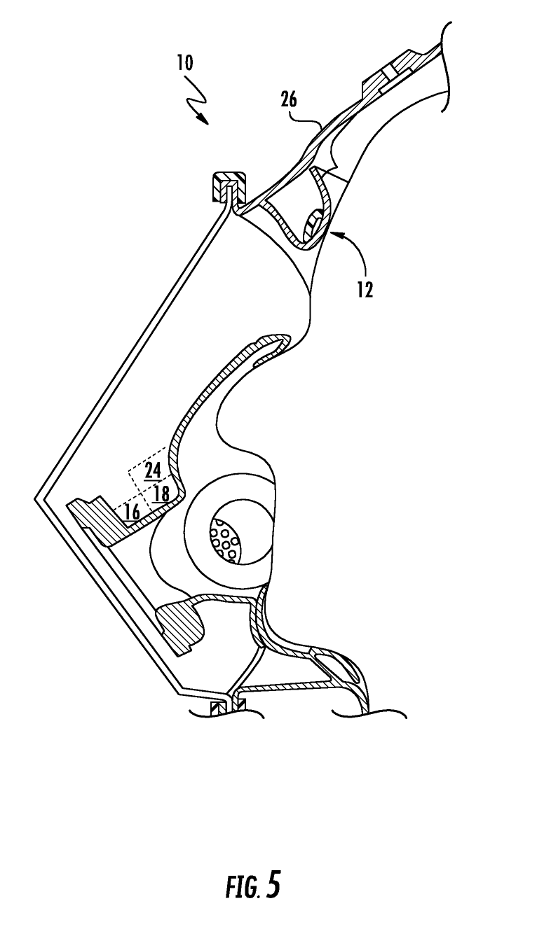

FIG. 4 illustrates a front view of one embodiment of integrated protective equipment 10 in accordance with the principles of the disclosure. In particular, integrated protective equipment 10, in this embodiment, includes protective face mask 26 that includes face piece 28 and regulator 30 as are known in the art, but the protective face mask has been integrated with sensor(s) 12, processor 16 and memory 18, as discussed above. While sensor 12, processor 16 and memory 18 are shown in specific locations in protective face mask 26, the locations of these components may be modified based on design need, .e.g., sensor 12 can be placed in different locations. FIG. 5 illustrates a side view of protect face mask 26 of FIG. 4. It is also contemplated that one or more of sensor 12, alert device 14, processor 16 and memory 18 may be integrated as a single device, such as provided on a substrate. Whether integrated on a single substrate or not, sensor 12, alert device 14, processor 16 and memory 18 may be removably or permanently affixed to a portion of the protective gear 26, or molded into the protective gear 26 such as the mask.

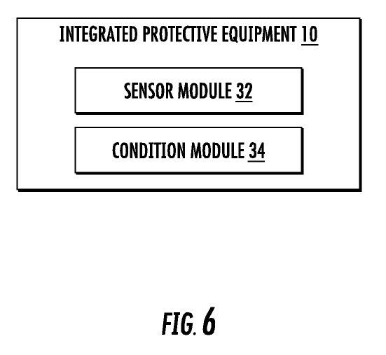

FIG. 6 illustrates a block diagram is another embodiment of integrated protective equipment 10. In particular, integrated protective device 10 includes sensor module 32 for performing and reporting measurements as discussed above with respect to sensor 12. Integrated protective device 10 further includes condition module 34 for performing the harmful condition process as discussed above with respect to condition code 20.

According to one aspect of the invention, integrated protective equipment 10 is provided. Integrated protective equipment 10 includes protective gear 26 and at least one sensor 12 affixed to protective gear 26. At least one sensor 12 is configured to generate sensor data. Integrated protective equipment 10 includes processing circuitry 23 affixed to protective gear 26 and in communication with the at least one sensor 12. Processing circuitry 23 includes processor 16 and memory 18. Memory 18 contains instructions that, when executed by processor 16, configure processor 16 to: receive the generated sensor data, and trigger an alert if the sensor data meets a predefined criteria, the predefined criteria include at least one threshold condition.

According to one embodiment of this aspect, memory 18 includes further instructions that, when executed by processor 16, cause processor 16 to determine analysis data based on the received sensor data, and trigger an alert if the analysis data meets a predefined criteria. According to one embodiment of this aspect, the sensor data includes a plurality of measurement values. The analysis data indicates an average value of the plurality of measurement values over a predefined period of time. According to one embodiment of this aspect, sensor 12 is a temperature sensor. The predefined criteria includes at least one temperature threshold condition.

According to one embodiment of this aspect, at least one sensor 12 is a plurality of sensors 12, The plurality of sensors 12 include at least two different types of sensors 12. According to one embodiment of this aspect, at least one of the plurality of sensors 12 is configured to measure a temperature of a user of integrated protective equipment 10. At least one other of the plurality of sensors 12 is configured to measure a characteristic of an environment where integrated protective equipment 10 is located. According to one embodiment of this aspect, protective gear 26 is a face mask.

According to another aspect of the invention, a method for integrated protective equipment 10 including a protective gear 26 and at least one sensor 12 affixed to the protective gear 26. The at least one sensor 12 is configured to generate sensor data. The generated sensor data is received (Block S100). An alert is triggered if the sensor data meets a predefined criteria (Block S102). The predefined criteria include at least one threshold condition. According to one embodiment of this aspect, analysis data is determined based on the received sensor data (Block S104). An alert is triggered if the analysis data meets a predefined criteria. According to one embodiment of this aspect, The sensor data includes a plurality of measurement values. The analysis data indicates an average value of the plurality of measurement values over a predefined period of time.

According to one embodiment of this aspect, the sensor data is temperature data. The predefined criteria includes at least one temperature threshold condition. According to one embodiment of this aspect, at least one sensor 12 is a plurality of sensors 12. The plurality of sensors 12 includes at least two different types of sensors 12. According to one embodiment of this aspect, at least one of the plurality of sensors 12 is configured to measure a temperature of a user of integrated protective equipment 10. At least one other of the plurality of sensors 12 is configured to measure a characteristic of an environment where integrated protective equipment 10 is located. According to one embodiment of this aspect, protective gear 26 is a protective mask.

According to another aspect of the invention, integrated protective equipment 10 is provided. Integrated protective equipment 10 includes sensor module 32 configured to generate sensor data, condition module 34 in communication with the sensor module 32. Condition module 34 is configured to: receive generated sensor data and trigger an alert if the sensor data meets a predefined criteria. The predefined criteria includes at least one threshold condition.

According to another aspect of the invention, integrated protective equipment 10 is provided. Integrated protective equipment 10 includes protective gear 26. Protective gear 26 is a face mask. Integrated protective equipment 10 includes a plurality of sensors 12 affixed to protective gear 26. Plurality of sensors 12 is configured to generate sensor data. Plurality of sensors 12 includes at least two different types of sensors 12 of which at least one type is a human temperature sensor. Integrated protective equipment 10 includes processing circuitry 23 affixed to the protective gear 26 and in communication with at least one sensor 12. Processing circuitry 23 includes processor 16 and memory 18. Memory 18 contains instructions that, when executed by processor 16, configure processor 16 to: receive the generated sensor data, determine analysis data by performing an analysis of the generated sensor data and trigger an alert if the analysis data meets a predefined criteria. The predefined criteria includes at least one human temperature threshold condition. The analysis data includes an average measurement value over a period of time.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. An integrated protective equipment, comprising:
a protective gear;
at least one sensor affixed to the protective gear, the at least one sensor configured to generate sensor data;
processing circuitry affixed to the protective gear and in communication with the at least one sensor, the processing circuitry including a processor and a memory, the memory containing instructions that, when executed by the processor, configure the processor to:
receive the generated sensor data; and
trigger an alert if the sensor data meets a predefined criteria, the predefined criteria include at least one threshold condition.

2. The integrated protective equipment of claim 1, wherein the memory includes further instructions that, when executed by the processor, cause the processor to:
determine analysis data based on the received sensor data; and trigger an alert if
the analysis data meets a predefined criteria.

3. The integrated protective equipment of claim 2, wherein the sensor data includes a plurality of measurement values; and
the analysis data indicates an average value of the plurality of measurement values over a predefined period of time.

4. The integrated protective equipment of claim 1, wherein the sensor is a temperature sensor; and
the predefined criteria includes at least one temperature threshold condition.

5. The integrated protective equipment of claim 1, wherein the at least one sensor is a plurality of sensors (12), the plurality of sensors (12) including at least two different types of sensors.

6. The integrated protective equipment of claim 5, wherein at least one of the plurality of sensors is configured to measure a temperature of a user of the integrated protective equipment; and
at least one other of the plurality of sensors is configured to measure a characteristic of an environment where integrated protective equipment is located.

7. The integrated protective equipment of claim 1, wherein the protective gear is a face mask.

8. A method for integrated protective equipment including a protective gear and at least one sensor affixed to the protective gear, the at least one sensor configured to generate sensor data, the method comprising:
receiving the generated sensor data; and
triggering an alert if the sensor data meets a predefined criteria, the predefined criteria include at least one threshold condition.

9. The method of claim 8, further comprising:
determining analysis data based on the received sensor data; and
triggering an alert if the analysis data meets a predefined criteria.

10. The method of claim 9, wherein the sensor data includes a plurality of measurement values; and
the analysis data indicates an average value of the plurality of measurement values over a predefined period of time.

11. The method of claim 8, wherein the sensor data is temperature data; and
the predefined criteria includes at least one temperature threshold condition.

12. The method of claim 8, wherein the at least one sensor is a plurality of sensors, the plurality of sensors including at least two different types of sensors.

13. The method of claim 12, wherein at least one of the plurality of sensors is configured to measure a temperature of a user of the integrated protective equipment; and
at least one other of the plurality of sensors is configured to measure a
characteristic of an environment where integrated protective equipment is located.

14. The method of claim 8, wherein the protective gear is a protective mask.

15. An integrated protective equipment, comprising:
a sensor module configured to generate sensor data; and
a condition module in communication with the sensor module, the condition module configured to:
receive generated sensor data; and
trigger an alert if the sensor data meets a predefined criteria, the predefined criteria includes at least one threshold condition.

16. An integrated protective equipment comprising:
a protective gear, the protective gear being a face mask;
a plurality of sensors affixed to the protective gear the plurality of sensors configured to generate sensor data, the plurality of sensors including at least two different types of sensors of which at least one type is a human temperature sensor;
processing circuitry affixed to the protective gear and in communication with the at least one sensor, the processing circuitry including a processor and a memory, the memory containing instructions that, when executed by the processor, configure the processor to:
receive the generated sensor data;
determine analysis data by performing an analysis of the generated sensor data, the analysis data including an average measurement value over a period of time; and
trigger an alert if the analysis data meets a predefined criteria,
the predefined criteria include at least one human temperature threshold condition.
